(19) United States
(12) Patent Application Publication
(10) Pub. No.: US 2026/0203702 A1
(43) Pub. Date: Jul. 16, 2026

(54) METHOD AND SYSTEM FOR ANALYZING LOGISTICS TRACKING EFFICIENCY

(71) Applicant: DEMON NETWORK TECH CO., LTD, Shenzhen (CN)

(72) Inventors: Lin PENG, Shenzhen (CN); Shengchen SUN, Shenzhen (CN); Yi HOU, Shenzhen (CN); Shoubao CHEN, Shenzhen (CN)

(73) Assignee: DEMON NETWORK TECH CO., LTD, Shenzhen (CN)

(21) Appl. No.: 19/373,100

(22) Filed: Oct. 29, 2025

(30) Foreign Application Priority Data
Jan. 14, 2025 (CN) 2025100584650

(51) Int. Cl. G06Q 10/0833

(52) U.S. Cl. CPC G06Q 10/0833

(57) ABSTRACT

A method and a system for analyzing logistics tracking efficiency. The method includes: obtaining a logistics trajectory, and recording a trajectory upload time and a trajectory query time; retrieving a corresponding logistics trajectory according to the logistics provider to be analyzed, the logistics state to be analyzed and the analysis date; calculating a trajectory delay time of each target logistics trajectory; dividing the analysis date into reference dates; calculating a number of the target logistics trajectory on each reference date; presetting multiple standard-reaching times; generating a monitor node on each reference date according to each standard-reaching time; determining whether the target logistics trajectory complies with each monitor node; calculating a trajectory compliance number of each monitor node; calculating a trajectory compliance rate of each monitor node; aggregating information of the trajectory compliance rate, the reference date, and the standard-reaching time; outputting or displaying aggregated information.

### TECHNICAL FIELD

The present application relates to the technical field of computers, and in particular to a method and a system for analyzing logistics tracking efficiency, and a logistics monitor board.

### BACKGROUND

The existing logistics tracking system is mainly used for querying the logistics order number, and the logistics trajectory information obtained from different logistics providers is processed and output to the user, so that the user can check the transportation progress of the logistics package in time. In the conventional logistics tracking system, users can only check the logistics trajectory information of the corresponding logistics order number.

However, there are thousands of logistics providers worldwide, and the logistics information of each logistics provider system is very different in data quality, operation specifications, implementation standards, and the like, which greatly increases the abnormalities probability in logistics queries, thereby affecting the logistics tracking efficiency. When the logistics query results are abnormal (especially hidden abnormalities, such as logistics time delay), it is difficult for users to find abnormality based on the logistics trajectory information, which makes it impossible for users to formulate corresponding countermeasures for abnormal conditions.

In addition, when the existing logistics tracking system outputs the query results, it only outputs the trajectory time, the trajectory position and trajectory description information of the logistics trajectory to the user for reference, which cannot reflect the service quality of the logistics provider and the tracking efficiency of the logistics tracking system.

Other technical issues related to the present application will be further described later. The above contents are only used to assist in understanding the technical solutions of the present application, and do not represent that all of the above contents are prior arts.

### SUMMARY

The main purpose of the present application is to provide a method and a system for analyzing logistics tracking efficiency, which can perform deep analysis on logistics query results, and judge the logistics time delay of logistics trajectory based on fluctuation of the trajectory compliance rate, thereby providing data support for users to select logistics providers and improve logistics tracking methods. In addition, the present application further provides a logistics monitor board for monitoring logistics trajectory information, so that logistics trajectory information can clearly reflect the service quality of logistics providers and the tracking efficiency of the logistics tracking system.

To achieve the above purpose, the present application proposes a method for analyzing logistics tracking efficiency including:
step S1, obtaining a logistics trajectory, and recording a trajectory upload time t1 and a trajectory query time t2 of each logistics trajectory, the trajectory upload time t1 being a time when a logistics provider uploads the logistics trajectory to a logistics provider system, the trajectory query time t2 being a query time when a logistics tracking system first queries and obtains a corresponding logistics trajectory;
step S2, determining a logistics provider to be analyzed, a logistics state to be analyzed, and an analysis date; retrieving the corresponding logistics trajectory according to the logistics provider to be analyzed, the logistics state to be analyzed and the analysis date;
defining a retrieved logistics trajectory as a target logistics trajectory, and calculating a trajectory delay time T of each target logistics trajectory, T being equal to t2−t1;
step S3, dividing the analysis date into N1 reference dates, N1 being not less than 1; calculating a number N2 of the target logistics trajectory on each reference date;
step S4, presetting N3 standard-reaching times, N3 being not less than 2; generating a corresponding monitor node on each reference date according to a value of each standard-reaching time, and determining whether the target logistics trajectory on each reference date complies with each monitor node; calculating a trajectory compliance number N4 of each monitor node, the trajectory compliance number being a number of the target logistics trajectory complying with the corresponding monitor node on a corresponding reference date, and the standard-reaching time being configured to compare a value of the trajectory delay time;
step S5, calculating a trajectory compliance rate of each monitor node, the trajectory compliance rate being a ratio of the trajectory compliance number of the corresponding monitor node to the number of the target logistics trajectory on the corresponding reference date; and
step S6, aggregating information of the trajectory compliance rate, the reference date, and the standard-reaching time corresponding to each monitor node; outputting or displaying aggregated information.

Other technical solutions and technical effects of the present application are described in the latter part of the specification. The technical problem and related product design solutions of the present application are described as follows.

Since the logistics provider system provides logistics information to inform the transportation progress of the logistics package (namely, transported goods), the logistics tracking system obtains very limited logistics information from the logistics provider system. Through the logistics tracking system, only the trajectory time, the trajectory position and trajectory description information of the corresponding logistics trajectory can be checked. However, it is difficult for users to judge whether the logistics effectiveness of the logistics provider or the logistics order number is abnormal based on the logistics trajectory information.

When evaluating the logistics effectiveness of the logistics provider, users usually compare the declared logistics time of the logistics provider with the actual logistics time of the logistics package. If the duration from the place of dispatch to the destination of the logistics package falls within the declared logistics time range of the logistics provider, the effectiveness of the logistics package is normal. Otherwise, the logistics effectiveness is abnormal. This method of judging logistics effectiveness is used to judge the actual logistics time delay based on the logistics time declared by the logistics provider. The disadvantage is that it can only judge the time delay of the entire logistics transportation stage, and cannot judge the time delay of a single logistics transportation stage (such as in the collection state, in the transportation state, in the arrival and waiting for pickup state, in the sending and delivery state, and the like). In addition, when judging the time delay of each logistics transportation stage, the lack of benchmark time in each logistics stage makes it difficult to judge the time delay in each stage.

If the average time and the deviation range of each logistics provider in each logistics transportation stage are calculated based on the historical logistics trajectory data of the logistics tracking system, the benchmark time of each logistics stage can be determined based on these average time and deviation range data, and the logistics time of the logistics trajectory can be judged. Although this time judgment method can determine the benchmark time of each logistics stage, following defects still exist. First, a large amount of historical logistics data is required to determine the benchmark time of each logistics provider in each logistics stage, which makes this method overly dependent on historical logistics data. If historical logistics data is missing, it is impossible to make the time delay judgment. Second, for multiple logistics packages of the same logistics provider, since the place of dispatch and destination cannot be exactly the same, the transportation time of each logistics stage will be very different, which will make the logistics time judgment of each logistics stage inaccurate. Third, based on a large amount of historical logistics trajectory information, the benchmark time in different logistics states of different logistics providers with different place of dispatches and destinations is calculated, which will greatly increase the cost of data calculation and storage.

The applicant further found that the existing logistics tracking system basically tracks logistics order numbers at a constant time. Usually, the query interval time (that is, the query period) of each logistics order number is 4-hour, 6-hour, 12-hour or 24-hour, which means that the logistics order number is queried once every 4, 6, 12 or 24 hours with a constant logistics trajectory query period. When the logistics time delay occurs, the upload time of the corresponding logistics trajectory will further be delayed. Since the query time of the logistics order number is constant, theoretically, the difference value between the query time of the logistics trajectory and the upload time of the logistics trajectory can reflect the logistics time delay to a certain extent (such as the first delay scenario and the second delay scenario described later). Defining the time when the logistics provider uploads the logistics trajectory to the logistics provider system as the trajectory upload time t1 (that is, trajectory generation time or online time), and the query time when the logistics tracking system first queries and obtains the corresponding logistics trajectory is the trajectory query time t2 of the logistics trajectory. The difference value between the trajectory query time and the trajectory upload time is the trajectory delay time T, namely T=t2−t1.

For example, in the embodiment A, the query period of the logistics tracking system for a logistics order number is 12-hour. The first logistics query time of the logistics order number is 18:00 on February 1st. Then, starting from the first query time, the logistics order number will be automatically queried every 12 hours. If the logistics state of the logistics package is in the transportation state, and the transportation is normal, the logistics package will arrive at the distribution center at 1:00 on February 2nd (assuming that the logistics trajectory can be generated immediately after the package arrives, and there is no lag in the online time), then the logistics tracking system will first obtain the logistics trajectory arriving at the distribution center from the logistics provider system at 6:00 on February 2nd.

For the first delay scenario, if the time for the logistics package to arrive at the distribution center is delayed to 2:00 on February 2nd, that is, the logistics delay time T1 is one hour, then the logistics tracking system will first obtain the logistics trajectory information of the logistics trajectory at 6:00 on February 2nd, and the trajectory delay time T is four-hour.

For the second delay scenario, if the time for the logistics package to arrive at the distribution center is delayed to 4:00 on February 2nd, that is, the logistics delay time T1 is three-hour, then the logistics tracking system will first obtain the logistics trajectory information at 6:00 on February 2nd, and the trajectory delay time T is two-hour.

For the third delay scenario, if the time for the logistics package to arrive at the distribution center is delayed to 17:00 on February 2nd, the logistics delay time T1 is 16-hour, then the logistics tracking system will first obtain the logistics trajectory information at 18:00 on February 2nd, and the trajectory delay time T is one-hour.

In the above delay scenarios, the first delay scenario and the second delay scenario are in the same query period (the time interval from 18:00 on February 1st to 6:00 on February 2nd). The more the trajectory delay time T, the less the logistics delay time T1. The trajectory delay time can reflect the delay in logistics time. However, the first delay scenario and the third delay scenario fall within different query periods. Although the trajectory delay time of the first delay scenario is less than that of the third delay scenario, the logistics delay time of the first delay scenario is more. It can be seen that although the trajectory delay time can reflect the logistics time delay to a certain extent in theory. In reality, the logistics delay time may span multiple logistics trajectory query periods, and it is impossible to determine in which logistics trajectory query period the logistics delay is located, making it difficult for the trajectory delay time to directly reflect the logistics delay time.

The applicant further found that if the logistics state corresponding to each logistics transportation stage is taken as the analysis object, and multiple standard-reaching times are preset for each logistics state, and these standard-reaching times can be distributed in different logistics trajectory query periods. Then in response to judging the logistics time of the logistics trajectory, the logistics state of the logistics trajectory to be analyzed can be first determined, and several historical logistics trajectories (that is, the target logistics trajectory) in the logistics state can be retrieved. In this way, it can be further judged that whether these target logistics trajectories comply with each standard-reaching time (monitor node), and the trajectory compliance rate within each standard-reaching time is calculated, then the trajectory compliance rate corresponding to each standard-reaching time under the conditions of the logistics provider, the logistics state and the analysis date can be calculated, so that whether each logistics trajectory within the corresponding analysis date is abnormal can be judged according to the fluctuation range of these trajectory compliance rates.

For example, in the embodiment B, when analyzing whether the logistics trajectory of a logistics provider from February 1st to February 4th is abnormal, the logistics state can be analyzed one by one. Table 1 shows the logistics data after analyzing the logistics tracking efficiency of the logistics trajectory in the “logistics transportation state”. The main operation steps are described as follows.

When obtaining the logistics trajectory, the trajectory upload time t1 and the trajectory query time t2 of each logistics trajectory are recorded, and the logistics state as well as the logistics provider and user (the user who queries the logistics trajectory) to which each logistics trajectory relates, are determined.

The historical logistics trajectory relating to the logistics provider and in the “logistics transportation state” is retrieved and configured as the target logistics trajectory for analysis. The analysis dates from February 1st to February 4th are divided into 4 reference dates. The number N2 of target logistics trajectories on each reference date is calculated, and the trajectory delay time T of each target logistics trajectory is calculated.

Further, seven standard-reaching times of 2H, 4H, 6H, 10H, 12H, 18H, and 24H, are preset, so that these standard-reaching times can include the query period of each logistics trajectory to be analyzed, and each reference date uses these seven standard-reaching times as monitor nodes. Then, it is determined that whether the target logistics trajectory of each reference date complies with each monitor node, and the trajectory compliance number N4 of each monitor node is calculated. If the trajectory delay time of a target logistics trajectory is less than (or not greater than) a certain standard-reaching time or the standard-reaching time corresponding to a monitor node, the target logistics trajectory complies with the monitor node. If the trajectory delay time of a target logistics trajectory is greater than the certain standard-reaching time or the standard-reaching time corresponding to a monitor node, the target logistics trajectory fails to comply with the monitor node.

For example, the number N2 of target logistics trajectories on the reference date of February 1st is 100. Among them, 60 target logistics trajectories have the trajectory delay time not greater than 2 hours, then the trajectory compliance number N4 of the monitor node corresponding to the standard-reaching time 2H on February 1st is 60, and the trajectory compliance rate of this monitor node is N4/N2=60%. Similarly, the trajectory compliance rate of other monitor nodes is calculated to form the deep logistics data shown in Table 1.

According to the analysis data in Table 1, 4 reference dates and 7 standard-reaching times constitute 28 monitor nodes. From the fluctuation range of the trajectory compliance rate of each monitor node, it can be seen that the trajectory compliance rate of the monitor node at the standard-reaching time position on February 4th is 30%, which is significantly lower than the trajectory compliance rate of the monitor node on other reference dates 2H and standard-reaching times. Therefore, it can be judged that the logistics trajectory on February 4th is abnormal.

TABLE 1

| | standard-reaching time | | | | | | |
|---|---|---|---|---|---|---|---|
| | 2 H | 4 H | 6 H | 10 H | 12 H | 18 H | 24 H |
| trajectory | 60.0% | 70.0% | 80.0% | 85.0% | 90.0% | 96.0% | 100.0% |
| compliance rate on | | | | | | | |
| February 1st | | | | | | | |
| trajectory | 70.0% | 80.0% | 85.0% | 90.0% | 91.0% | 95.0% | 100.0% |
| compliance rate on | | | | | | | |
| February 2nd | | | | | | | |
| trajectory | 65.0% | 75.0% | 80.0% | 90.0% | 95.0% | 98.0% | 100.0% |
| compliance rate on | | | | | | | |
| February 3rd | | | | | | | |
| trajectory | 30.0% | 45.0% | 80.0% | 85.0% | 90.0% | 95.0% | 99.0% |
| compliance rate on | | | | | | | |
| February 4th | | | | | | | |

By this method for analyzing logistics tracking efficiency, the logistics tracking capability of the logistics tracking system for each logistics trajectory can be calculated, and deep analysis can be performed on the logistics query results, to discover logistics time anomalies in advance (including logistics time delay, untimely logistics tracking, logistics trajectory information upload lag and other hidden anomalies), so that the query service provided by the logistics tracking system can be timely and transparently informed to users, and data support can be provided for users to select logistics providers and improve logistics tracking methods. This method is simple to operate, and does not require complex logistics effectiveness analysis for the place of dispatch and destination of logistics packages, and can further clearly present the logistics time delay. Even if there is only one target logistics trajectory, the analysis results can be output normally.

In addition, the present application further provides a logistics monitor board for monitor logistics trajectory, including following modules.

A trajectory acquisition module is configured to acquire logistics trajectory.

A condition setting module is configured to set the logistics provider to be analyzed, the logistics state to be analyzed and the analysis date, and configured to retrieve the corresponding logistics trajectory as the monitor object according to the logistics provider to be analyzed, the logistics state to be analyzed and the analysis date.

A node control module is configured to preset multiple standard-reaching time, and generate corresponding monitor nodes based on the multiple standard-reaching time and the analysis date.

A monitor analysis module is configured to calculate the trajectory compliance rate of each monitor node based on the trajectory delay time and the standard-reaching time. If the more quantity of logistics trajectories that the trajectory delay time is less than the logistics trajectory of the standard-reaching time, then the greater the trajectory compliance rate of the corresponding monitoring node.

An information display module is configured to aggregate and display information of the trajectory compliance rate, the analysis date and the standard-reaching time of each monitor node.

The logistics monitor board can perform various operations of the above-mentioned method for analyzing logistics tracking efficiency, provide an interactive interface for convenient operation, reduce the user understanding cost for logistics tracking efficiency analysis, and make simple logistics trajectory information clearly reflect the service quality of logistics providers and the tracking efficiency of the logistics tracking system. In addition, the logistics monitor board can be used as a part of the logistics tracking system, which is convenient for users to query the logistics trajectory and timely analyze the logistics tracking efficiency of the corresponding logistics trajectory.

Furthermore, the present application further provides a system corresponding to various methods. The system includes the functional modules in the present application, executes operation instructions of the corresponding functional modules or the corresponding methods, and outputs relevant data information to the front-end interface of the system. The system is stored in a server and/or computer device including a processor, and the processor is configured to execute operation instructions of the system.

Disclaimer: The functional modules of the present application can be combined with each other, or can exist independently, or one functional module can be a sub-module of another functional module. Step numbers, such as S1 and S2, do not limit the order of the corresponding operation steps.

Description of relevant terms in the present application is as follows (the letters of English words are not case-sensitive).
(1) Logistics trajectory can be used to indicate the logistics routing information of a package (goods) from the delivery state to the received state, including the trajectory time, the trajectory position and the trajectory description (such as the package state, and the like) of the package in the corresponding logistics link. Through lots of logistics trajectory information of the same logistics order number, the transportation process of the package is presented.
(2) Coordinated Universal Time (UTC) is a time measurement standard based on the length of atomic seconds, while Greenwich Mean Time (GMT) is a time measurement standard based on the zero degree longitude of the earth.

### BRIEF DESCRIPTION OF THE DRAWINGS

The accompanying drawings are used to provide further understanding of the present application and do not constitute a limitation of the present application. Contents shown in the accompanying drawings can be real data of the embodiments and belong to the protection scope of the present application.

FIG. 1 is a schematic diagram showing the principle for analyzing the logistics tracking efficiency according to an embodiment of the present application.

FIG. 2 is a flowchart of a method for analyzing logistics tracking efficiency according to an embodiment of the present application.

FIG. 3 is an interactive interface diagram of a logistics monitor board according to an embodiment of the present application.

FIG. 4 is a schematic structural diagram of a logistics monitor board according to an embodiment of the present application.

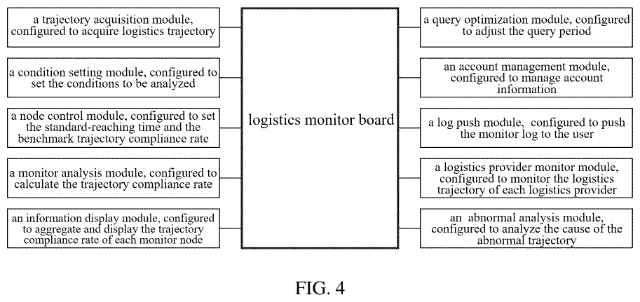

### DETAILED DESCRIPTION OF THE EMBODIMENTS

In order to make the purpose, technical solutions and advantages of the present application clearer, embodiments of the present application are further described in detail by means of embodiments in combination with the accompanying drawings. It should be understood that the embodiments described herein are only used to explain the present application and are not used to limit the present application.

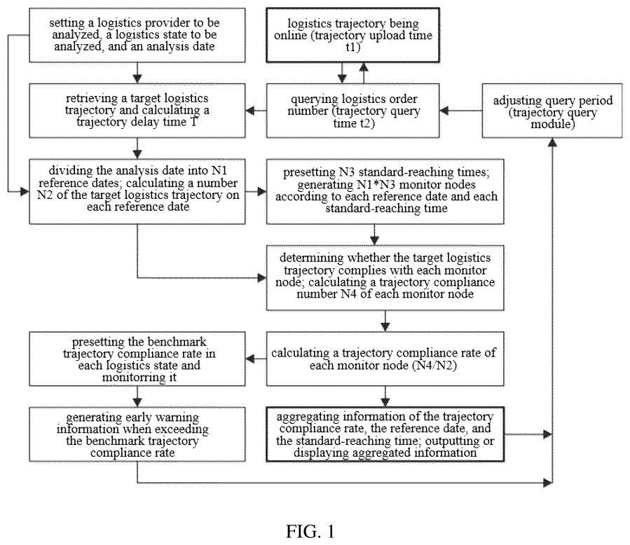

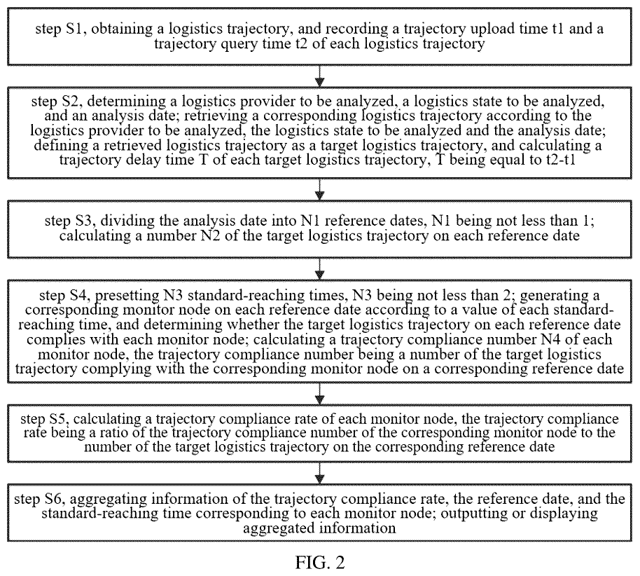

As shown in FIG. 1 to FIG. 2, the present application proposes a method for analyzing logistics tracking efficiency, and the method further includes following steps S1 to S6.

Step S1, obtaining the logistics trajectory from the logistics provider system, recording the trajectory upload time t1 and the trajectory query time t2 of each logistics trajectory, and storing corresponding information of the logistics trajectory in the database of the logistics tracking system. The obtained logistics trajectory can be called the historical logistics trajectory. The trajectory upload time t1 is a time when a logistics provider uploads the logistics trajectory to a logistics provider system, and the trajectory query time t2 is a query time when a logistics tracking system first queries and obtains a corresponding logistics trajectory.

Step S2, determining the logistics provider to be analyzed, the logistics state to be analyzed and the analysis date, retrieving the corresponding logistics trajectory according to the logistics provider to be analyzed, the logistics state to be analyzed and the analysis date, defining the retrieved logistics trajectory as the target logistics trajectory, and calculating the trajectory delay time T of each target logistics trajectory. T=t2−t1. In the present application, retrieving means screening and calling.

Step S3, dividing the analysis date into N1 reference dates, N1 being not less than 1, and calculating the number N2 of target logistics trajectories on each reference date. In other embodiments, the reference date can be changed to a reference time with other time lengths, such as half a day or a week as a reference time.

Step S4, presetting N3 standard-reaching time, N3 being not less 2, generating corresponding monitor nodes on each reference date according to the value of each standard-reaching time, judging whether the target logistics trajectory on each reference date complies with each monitor node; calculating the trajectory compliance number N4 of each monitor node, the trajectory compliance number referring to the number of target logistics trajectories that comply with the corresponding monitor node (or the standard-reaching time corresponding to the monitor node) on the corresponding reference date. The standard-reaching time is configured to compare a value of the trajectory delay time.

Step S5, calculating the trajectory compliance rate of each monitor node, the trajectory compliance rate being the ratio of the trajectory compliance number of the corresponding monitor node to the number of target logistics trajectories on the corresponding reference date. That is, trajectory compliance rate=N4/N2.

Step S6, aggregating information of the trajectory compliance rate, the reference date, and the standard-reaching time corresponding to each monitor node, and outputting or displaying the aggregated information.

In an embodiment, when N3 standard-reaching times is presetting, the shortest standard-reaching time may be not grater than 2 hours and the longest standard-reaching time may not less than 20 hours, so that most of the logistics trajectory query periods can be taken into account, and the analysis accuracy of logistics tracking efficiency can be improved. In addition, before calculating the trajectory delay time T, the trajectory upload time t1 and the trajectory query time t2 are converted into the same time unit, and the time unit adopts the UTC or GMT time measurement standard.

In an embodiment, the logistics time delay of the logistics trajectory can further be evaluated by the trajectory non-compliance rate. In step S5, the trajectory non-compliance rate is calculated, and the trajectory non-compliance rate=1-trajectory compliance rate. Then in step S6, information of the trajectory non-compliance rate, the reference date, and the standard-reaching time corresponding to each monitor node is aggregated, and the aggregated information is output or displayed. In step S4, the trajectory non-compliance number N5 of each monitor node can further be directly calculated, and the trajectory non-compliance rate=N5/N2.

In an embodiment, when the target logistics trajectory is retrieved according to the analysis date, the logistics trajectory with the same trajectory upload time or the same trajectory query time as the analysis date can be retrieved. That is, the analysis date is the date corresponding to the trajectory upload time or the date corresponding to the trajectory query time.

In an embodiment, in step S2, the logistics provider to be analyzed, the logistics state to be analyzed and the analysis date are defined as conditions to be analyzed, and the corresponding target logistics trajectory is retrieved according to the conditions to be analyzed.

When conditions to be analyzed include multiple logistics states, the trajectory compliance rate in each logistics state at the monitor node is calculated respectively. In response to a specified logistics state, the trajectory compliance rate of each corresponding monitor node in the specified logistics state is output or displayed in step S6, so as to facilitate the targeted review for the logistics trajectory in the logistics state.

In addition, when the conditions to be analyzed include multiple logistics providers, the trajectory compliance rate of each logistics provider in each logistics state at the monitor node is calculated respectively. In response to the specified logistics state, the reference date and the standard-reaching time, the sorting information of each logistics provider according to the trajectory compliance rate under the condition of the specified logistics state, the reference date and the standard-reaching time is output or displayed in step S6, so as to screen logistics providers with different trajectory delays, rank these logistics providers, and provide data support for users to select or replace logistics providers.

In an embodiment, the “trajectory compliance rate” can be called “update effectiveness rate” or “query effectiveness rate” and other terms, so that the user can better understand the relationship between the logistics trajectory delay time and each standard-reaching time.

In an embodiment, the logistics trajectory within the monitor date can further be automatically monitored based on the above-mentioned method for analyzing logistics tracking efficiency, as shown in steps S71 to S73.

Step S71, presetting the monitor date, determining the monitored logistics state and the monitored standard-reaching time of the monitored logistics provider, and setting the benchmark trajectory compliance rate based on each monitored logistics state and each monitored standard-reaching time of the monitored logistics provider. The monitor date can be the same day or the previous day when the logistics tracking efficiency is analyzed, or can be the most recent week or other time. After setting the monitor date, the logistics tracking system automatically calculates the trajectory compliance rate of the monitor date, and monitors the abnormal situation of the logistics trajectory.

Step S72, configuring the logistics trajectory belonging to the monitored logistics state on the monitor date as the target logistics trajectory, generating the corresponding monitor node on the monitor date according to the value of the monitored standard-reaching time; and calculating the monitor trajectory compliance rate of each monitor node based on the number of target logistics trajectories on the monitor date. The monitor trajectory compliance rate is the ratio of the number (N4) of target logistics trajectories that comply with the corresponding monitor node on the monitor date to the number (N2) of target logistics trajectories on the monitor date.

Step S73, when the monitor trajectory compliance rate is less than (or less than or equal to) the benchmark trajectory compliance rate, generating early warning information based on the monitored logistics state and the monitored standard-reaching time.

For example, in the embodiment C, when monitoring whether the logistics trajectory of the logistics provider USPS in the past week (that is, the monitor date) is abnormal, the benchmark trajectory compliance rate of USPS (that is, the monitored logistics provider) in the collection state (that is, the monitored logistics state) with 10-hour standard-reaching time (that is, the monitored standard-reaching time) is set to 80%. In this case, the historical logistics trajectory in the collection state of USPS in the past week is the target logistics trajectory, and the monitor node A is generated corresponding to the collection state and the 10-hour standard-reaching time. The monitor node A can further be regarded as the coordinate position corresponding to the collection state and the 10-hour standard-reaching time. Then the number (N2) of target logistics trajectories in the past week is calculated, and the number (N4) of target logistics trajectories that comply with the corresponding monitor node in the past week is calculated, and then the value of N4/N2 is used as the monitor trajectory compliance rate. When the monitor trajectory compliance rate is less than the benchmark trajectory compliance rate, early warning information of the monitor node A (corresponding to the collection state and 10-hour standard-reaching time) is generated to remind users to pay attention to the abnormal logistics trajectory of the monitor node. Similarly, the benchmark trajectory compliance rate can be set based on other monitor dates, other monitor logistics providers, other monitor logistics states, and other monitor standard-reaching times to generate more monitor nodes, so as to automatically, flexibly, and completely monitor logistics trajectory information and improve efficiency and quality of logistics tracking.

In other embodiments, the screening conditions may be set first, which includes but is not limited to, one or more of the analysis date, the logistics provider, the logistics state and the standard-reaching time, and then the corresponding logistics trajectory is retrieved as the target logistics trajectory according to the screening conditions. Then it is determined whether the retrieved target logistics trajectory complies with the standard-reaching time, and the proportion of the number of the complied target logistics trajectory in the total number of the retrieved target logistics trajectory is configured as the trajectory compliance rate. After that, the trajectory compliance rate information corresponding to each standard-reaching time is aggregated and output. In this way, the user can flexibly set the screening conditions, and the system automatically outputs the corresponding trajectory compliance rate information, so that the time information of the logistics trajectory under each condition can be quickly and completely analyzed.

In an embodiment, when obtaining the logistics trajectory, the query period of each logistics trajectory is recorded, the duration of the monitor date is configured as the monitor period. The number (N6) of monitor nodes whose trajectory compliance rate is less than the benchmark trajectory compliance rate is defined as the warning number. If the warning number in a monitored logistics state is less than the preset warning number (that is, the first adjustment condition is met), the query period in the monitored logistics state is reduced during the next monitor period (that is, the first adjustment strategy is executed during the query period) to ensure that the logistics tracking system obtains the logistics trajectory in time. The query period is adjusted within a predetermined time range, such as a minimum query period of 2-hour and a maximum query period of 48-hour. In an embodiment, the preset warning number can be set according to the number N3 of standard-reaching time. When N337, the preset warning number is 3. When N3≥8, the preset warning number is the value of the integer part of 0.5*N3.

Further, from the multiple monitored standard-reaching times corresponding to the monitored logistics state, a monitored standard-reaching time is selected as the benchmark standard-reaching time. When the second adjustment condition is met, the query period in the monitored logistics state is increased during the next monitor period (that is, the second adjustment strategy is executed during the query period). The second adjustment condition includes: the warning number in the monitored logistics state is less than the preset warning number, there is at least one standard-reaching time that is less than the benchmark standard-reaching time, and its corresponding monitor trajectory compliance rate is greater than or equal to (≥) the benchmark trajectory compliance rate of the benchmark standard-reaching time.

For example, as shown in Table 1, the monitor date is from February 1st to February 4th, and the monitor period is 4-day. If each standard-reaching time is used as the monitor standard-reaching time, the benchmark trajectory compliance rate corresponding to the 10-hour standard-reaching time is 80%, and the 10-hour monitored standard-reaching time is configured as the benchmark standard-reaching time. The warning number is less than the preset warning number. Since the trajectory compliance rate of the 6-hour standard-reaching time not less than the benchmark trajectory compliance rate is 80%, the second condition is met, and the query period can be increased during the next monitor period (from February 5th to February 8th).

In an embodiment, the abnormal cause of the logistics trajectory can be judged based on the query period and the trajectory compliance rate of the logistics trajectory. Specifically, the query period of the logistics trajectory can be used as the first standard-reaching time, and the first standard-reaching time can be the standard-reaching time with the longest time length. The trajectory compliance rate (defined as the first trajectory compliance rate) corresponding to the first standard-reaching time within the monitor date is calculated. If the first trajectory compliance rate is less than 100%, it is determined that the reason for the abnormality of the logistics trajectory is that the logistics tracking system queries the logistics trajectory abnormally, and corresponding prompt information is generated.

For example, in the embodiment D, as shown in Table 1, if the query period of the logistics tracking system is 24-hour, the standard-reaching time of 24-hour is used as the first standard-reaching time. In this case, if time on February 4th is used as the monitor time, the first trajectory compliance rate is 99%, indicating that there are still 1% of the logistics trajectories whose trajectory delay time exceeds 24 hours. The logistics trajectory with trajectory delay time exceeding 24 hours has abnormal trajectories due to the abnormalities in the logistics trajectory (such as logistics order number recognition error, missed query period, logistics trajectory data processing error, and the like), rather than the logistics provider logistics time delay or logistics trajectory information upload lag. Therefore, the reason for the abnormality of the logistics trajectory can be judged by the query period and the first trajectory compliance rate, and the corresponding prompt information can be generated to feedback the corresponding trajectory abnormality to the user to improve the logistics tracking efficiency.

In addition, the present application further provides a logistics monitor board for monitoring the logistics trajectory, including a trajectory acquisition module for acquiring the logistics trajectory, a condition setting module, a node control module, a monitor analysis module, and an information display module.

The condition setting module is configured to set the logistics provider to be analyzed, the logistics state to be analyzed and the analysis date (namely, conditions to be analyzed), and retrieve the corresponding logistics trajectory as the monitor object (that is, the target logistics trajectory) according to the logistics provider to be analyzed, the logistics state to be analyzed and the analysis date. The node control module is configured to preset multiple standard-reaching times, and generate corresponding monitor nodes based on the multiple standard-reaching times and the analysis date. The monitor and analysis module calculates the trajectory compliance rate of each monitor node based on the trajectory delay time and the standard-reaching time. If the logistics trajectory with a trajectory delay time less than the standard-reaching time is more, the trajectory compliance rate of the corresponding monitor node is greater. An information display module is configured to aggregate and display information of the trajectory compliance rate, the analysis date and the standard-reaching time of each monitor node.

In an embodiment, the information display module displays information of the trajectory compliance rate, the analysis date and the standard-reaching time corresponding to each monitor node (including the second monitor node and the monitor node described in step S4 and step S72) through a chart and/or a table. The table can be in the form of the above-mentioned Table 1.

When the information display module includes the chart, the standard-reaching time is used as the horizontal axis and the trajectory compliance rate is used as the vertical axis in the chart and, to display the coordinate points of the corresponding monitor node. The analysis date is divided into multiple reference dates. Coordinate points of each monitor node on the same reference date are marked with the same color. Coordinate points of each monitor node on different reference dates are marked with different colors. After that, the coordinate points of each monitor node on the same reference date are connected into a curve in the order of the standard-reaching time, and the curve is used as the trajectory compliance rate curve. In this way, the logistics trajectory information of three dimensions can be displayed in a two-dimensional chart, and the monitor node with a large change in trajectory compliance rate is clearly presented, so that users can quickly find abnormal logistics trajectory data.

In addition, each reference date option can be displayed in different colors in the chart, and the color of each reference date option is the same as the coordinate point color of the corresponding monitor node. If the corresponding reference date is selected, the trajectory compliance rate curve of the corresponding reference date is displayed, otherwise, the trajectory compliance rate curve of the corresponding reference date is not displayed. Thus, the trajectory compliance rate of different reference dates can be compared and analyzed in a targeted manner.

In an embodiment, for the condition setting module, the logistics provider to be analyzed, the logistics state to be analyzed and the analysis date are set through the interactive method of the filter box. After the logistics trajectory of each monitor node is calculated, information of the trajectory compliance rate, the analysis date and the standard-reaching time of each monitor node are generated into a monitor file through the export control key.

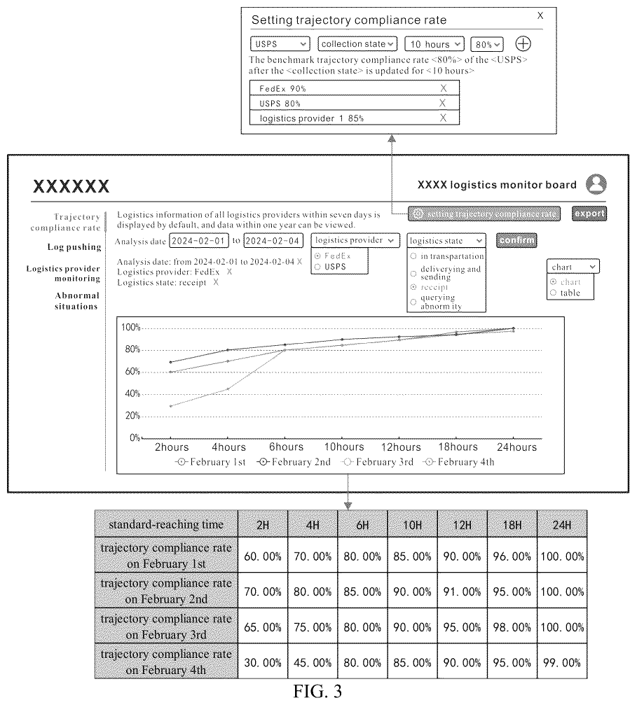

As shown in the key setting interface in FIG. 3 of “setting trajectory compliance rate”, the node control module can further be used to set the benchmark trajectory compliance rate. The node control module sets the benchmark trajectory compliance rate corresponding to the monitored logistics provider, the monitored logistics state and the monitored standard-reaching time, determines the monitor date, generates the corresponding second monitor node based on the monitor date and the monitored standard-reaching time, and uses the trajectory compliance rate of the second monitor node as the monitor trajectory compliance rate. When the monitor trajectory compliance rate is less than the benchmark trajectory compliance rate, early warning information is generated based on the monitored logistics state and the monitored standard-reaching time. That is, steps S71 to S73 are performed, and the monitor date can be the analysis date or other reset time.

In an embodiment, the monitor board further includes a query optimization module, which records the query period of each logistics trajectory through the trajectory acquisition module, configures the duration of the monitor date as the monitor period, and defines the number of monitor nodes whose trajectory compliance rate is less than the benchmark trajectory compliance rate as the warning number. When the warning number in the monitored logistics state is less than the preset warning number, the query optimization module executes the first adjustment strategy during the query period, and the first adjustment strategy includes reducing the query period in the monitored logistics state during the next monitor period.

Further, from the multiple monitored standard-reaching times corresponding to the monitored logistics state, a monitored standard-reaching time is selected as the benchmark standard-reaching time. When the second adjustment condition is met, the query optimization module executes a second adjustment strategy for the query period, and the second adjustment strategy includes increasing the query period in the monitored logistics state during the next monitor period. The second adjustment condition includes: the warning number in the monitored logistics state is less than the preset warning number; there is at least one standard-reaching time that is less than the benchmark standard-reaching time, and its corresponding monitor trajectory compliance rate is greater than or equal to the benchmark trajectory compliance rate of the benchmark standard-reaching time.

In addition, the monitor board can further include one or more of an account management module, a log push module, a logistics provider monitor module, and an abnormality analysis module. The account management module is used to manage the user account information of the logistics monitor board (logistics tracking system). After the user logs in to the account, only the logistics trajectory queried through the account is retrieved as the monitor object. The log push module is used to push the monitor log to the user, such as by email, system message, mobile phone text message, and the like, to push the monitor log to the user within the corresponding analysis date. The content of the monitor log can be the logistics trajectory information regularly and automatically monitored by the system, or the early warning information when the trajectory is abnormal. The logistics provider monitor module is used to monitor the logistics trajectory data of each logistics provider, and manage the logistics trajectory monitor data of each logistics provider during different time periods. The abnormal analysis module is used to analyze the cause of the abnormal trajectory. After the early warning information of the abnormal logistics trajectory is generated, the abnormal information is analyzed and an abnormal analysis report is generated. For example, in the above embodiment D, the cause of the abnormal logistics trajectory is recorded through the abnormal analysis report.

The above are only some embodiments of the present application, and do not limit the scope of the present application thereto. Under the concept of this application, any equivalent transformation made according to the description and drawings of the present application, or direct/indirect applied in other related technical fields shall fall within the claimed scope of the present application.

What is claimed is:

1. A method for analyzing logistics tracking efficiency, the method comprising:
obtaining a logistics trajectory and recording a trajectory upload time and a trajectory query time of each logistics trajectory, wherein the trajectory upload time is a time when a logistics provider uploads the logistics trajectory to a logistics provider system, the trajectory query time is a query time when a logistics tracking system first queries and obtains a corresponding logistics trajectory;
determining a logistics provider to be analyzed, a logistics state to be analyzed, and an analysis date; retrieving the corresponding logistics trajectory according to the logistics provider to be analyzed, the logistics state to be analyzed and the analysis date; defining a retrieved logistics trajectory as a target logistics trajectory, and calculating a trajectory delay time of each target logistics trajectory;
dividing the analysis date into N1 reference dates; calculating a number N2 of the target logistics trajectory on each reference date;
presetting N3 standard-reaching times, wherein N3 is not less than 2; generating a corresponding monitor node on each reference date according to a value of each standard-reaching time, and determining whether the target logistics trajectory on each reference date complies with each monitor node; calculating a trajectory compliance number of each monitor node, wherein the trajectory compliance number is a number of the target logistics trajectory complying with the corresponding monitor node on a corresponding reference date, and the standard-reaching time is configured to compare a value of the trajectory delay time;
calculating a trajectory compliance rate of each monitor node, wherein the trajectory compliance rate is a ratio of the trajectory compliance number of the corresponding monitor node to the number of the target logistics trajectory on the corresponding reference date; and
aggregating information of the trajectory compliance rate, the reference date, and the standard-reaching time corresponding to each monitor node; outputting or displaying the aggregated information.

2. The method according to claim 1, wherein, in response to the trajectory delay time of the target logistics trajectory being less than a standard-reaching time corresponding to a monitor node, the target logistics trajectory complies with the monitor node; or
in response to the trajectory delay time of the target logistics trajectory being greater than a standard-reaching time corresponding to a monitor node, the target logistics trajectory fails to comply with the monitor node.

3. The method according to claim 1, further comprising:
in response to presetting N3 standard-reaching times, taking a value in a range from a shortest standard-reaching time not greater than 2 hours to a longest standard-reaching time not less than 20 hours; and/or
before calculating the trajectory delay time, converting a trajectory upload time and a trajectory query time into a same time unit, wherein Universal Time Coordinated or Greenwich Mean Time is configured as a time measurement standard of the time unit; and/or
calculating a trajectory non-compliance rate, and the trajectory non-compliance rate is equal to 1−trajectory compliance rate; and aggregating information of the trajectory non-compliance rate, the reference date, and the standard-reaching time corresponding to each monitor node;
outputting or displaying aggregated information.

4. The method according to claim 1, wherein, in response to retrieving the target logistics trajectory according to the analysis date, retrieving a logistics trajectory with a same trajectory upload time or a same trajectory query time as the analysis date.

5. The method according to claim 1, further comprising:
defining the logistics provider to be analyzed, the logistics state to be analyzed, and the analysis date as conditions to be analyzed, and retrieving a corresponding target logistics trajectory according to the conditions to be analyzed; and
in response to the conditions to be analyzed comprising a plurality of logistics states, calculating the trajectory compliance rate of each logistics state at the monitor node separately; and in response to a specified logistics state, outputting or displaying the trajectory compliance rate of each corresponding monitor node in a specified logistics state.

6. The method according to claim 5, further comprising:
in response to the conditions to be analyzed comprising a plurality of logistics providers, calculating the trajectory compliance rate of each logistics provider in each logistics state on the monitor node separately; and
in response to the specified logistics state, the reference date and the standard-reaching time, outputting or displaying sorting information of each logistics provider according to the trajectory compliance rate under conditions of the specified logistics state, the reference date and the standard-reaching time.

7. The method according to claim 1, further comprising:
presetting a monitor date, determining a monitored logistics state and a monitored standard-reaching time of a monitored logistics provider, and setting a benchmark trajectory compliance rate based on each monitored logistics state and each monitored standard-reaching time of the monitored logistics provider;
configuring a logistics trajectory belonging to the monitored logistics state within the monitor date as the target logistics trajectory, and generating a corresponding monitor node on the monitor date according to a value of the monitored standard-reaching time; calculating a monitor trajectory compliance rate at each monitor node based on the number of the target logistics trajectory within the monitor date, wherein the monitor trajectory compliance rate is equal to a ratio of the number of the target logistics trajectory complying with the corresponding monitor node on the monitor date to the number of the target logistics trajectory on the monitor date; and
in response to the monitor trajectory compliance rate being less than the benchmark trajectory compliance rate, generating early warning information based on the monitored logistics state and the monitored standard-reaching time.

8. The method according to claim 7, further comprising:
in response to acquiring the logistics trajectory, recording a query period of each logistics trajectory, configuring a duration of the monitor date as a monitor period, and defining a number of the monitor node with monitor trajectory conformance rate being less than the benchmark trajectory compliance rate as a warning number; and
in response to a warning number in the monitored logistics state being less than a preset warning number, reducing the query period in the monitored logistics state during a next monitor period.

9. The method according to claim 8, further comprising:
selecting one monitored standard-reaching time as a benchmark standard-reaching time from a plurality of monitored standard-reaching times corresponding to the monitored logistics state; and
in response to a second adjustment condition being met, increasing the query period in the monitored logistics state during the next monitor period, wherein the second adjustment condition comprises: the warning number in the monitored logistics state being less than the preset warning number; at least one standard-reaching time being less than the benchmark standard-reaching time, and the monitor trajectory compliance rate corresponding to the at least one standard-reaching time being greater than or equal to the benchmark trajectory compliance rate.

10. A logistics tracking system, wherein the logistics tracking system executes operation instructions in the method for analyzing logistics tracking efficiency according to claim 1.
